(19) United States
(12) Patent Application Publication
(10) Pub. No.: US 2008/0169392 A1
(43) Pub. Date: Jul. 17, 2008

(54) Bracket for mounting a utility meter transponder

(76) Inventors: Randy K. McClure, Rialto, CA (US); Elaine Carvalho, Rialto, CA (US)

Correspondence Address: LAW OFFICES OF ERIC KARICH, 2807 ST. MARK DR., MANSFIELD, TX, 76063, US

(21) Appl. No.: 11/652,844

(22) Filed: Jan. 12, 2007

(51) Int. Cl. F16L 3/00

(52) U.S. Cl. 248/226.11

(57) ABSTRACT

A mounting bracket for mounting a utility meter transponder on a lip of a meter box has a base element adapted to abut the meter box, and a mounting flange extending outwardly from the base element to engage the lip of the meter box. A fastener is adapted to fasten the base element to the meter box; and a transponder mounting element extending downwardly from the base element opposite the mounting flange. The transponder mounting element is adapted to mount the utility meter transponder.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to brackets, and more particularly to a mounting bracket for mounting a utility meter transponder adjacent a lip of a meter box.

2. Description of Related Art

To facilitate reading utility meters, many cities are installing utility meter transponders adjacent the utility meter to enable wireless reporting of utility meters via the utility meter transponder. If the utility meter transponder is simply placed underground next to the utility meter, however, it may be difficult for the utility meter transponder to communicate with the wireless network. Also, utility, bugs, and other environmental factors may damage the utility meter transponder if it is left resting on the ground. To ensure that the utility meter transponders are mounted above the ground and able to communicate with the wireless network, it is important that the utility meter transponder be mounted adjacent the top of the meter box.

The prior art teaches mounting the utility meter transponder on a post driven into the ground adjacent a utility meter.

In another embodiment, Maddox, U.S. Pat. No. 6,568,645, teaches mounting a utility meter transponder on an upwardly extending post that is adapted to be mounted on a pipe adjacent the utility meter.

However, the prior art does not teach a bracket that is attached to the meter box and adapted to mount the transponder. The present invention fulfills these needs and provides further related advantages as described in the following summary.

### SUMMARY OF THE INVENTION

The present invention teaches certain benefits in construction and use which give rise to the objectives described below.

The present invention provides a mounting bracket for mounting a utility meter transponder on a lip of a meter box. The mounting bracket includes a base element adapted to abut the meter box. The mounting bracket also includes a mounting flange extending outwardly from the base element and adapted to engage the lip of the meter box. A fastener is adapted to fasten the base element to the meter box once the mounting flange has engaged the lip; and a transponder mounting element extending downwardly from the base element opposite the mounting flange. The transponder mounting element is adapted to mount the utility meter transponder.

A primary objective of the present invention is to provide a mounting bracket having advantages not taught by the prior art.

Another objective is to provide a mounting bracket that is fastened to the meter box with a fastener so that the bracket is securely attached to the meter box.

Another objective is to provide a mounting bracket that includes a flange for engaging a lip of the meter box, thereby ensuring that the mounting bracket is correctly and securely located with respect to the lip.

Another objective is to provide a mounting bracket that maintains the utility meter transponder at a predetermined distance from a top edge of the meter box, and at a fixed antennae height.

Another objective is to provide a mounting bracket that is inexpensive to manufacture and easy to install.

A further objective is to provide a method for mounting a utility meter transponder using the above-described mounting bracket.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is an exploded perspective view of a transponder system according to a preferred embodiment of the present invention, the transponder system including a utility meter transponder and a mounting bracket for mounting the utility meter transponder to a meter box adjacent a lip of the utility meter box;

FIG. 2 is a sectional view thereof taken along line 2-2 in FIG. 1;

FIG. 3 is rear perspective view of a second embodiment of the transponder system;

FIG. 4 is front perspective view of a third embodiment of the transponder system;

FIG. 5A is a perspective view of a fourth embodiment of the transponder system;

FIG. 5B is a sectional view thereof taken along line 5-5 in FIG. 5A; and

FIG. 6 is a perspective view of a fifth embodiment of the transponder system.

### DETAILED DESCRIPTION OF THE INVENTION

The above-described drawing figures illustrate the invention, a transponder system 10 including a mounting bracket 20 for mounting a utility meter transponder 12 adjacent a lip 14 of a meter box 13. The utility meter transponder 12 is operably attached to a utility meter 16 (such as a water meter) with a cord 18.

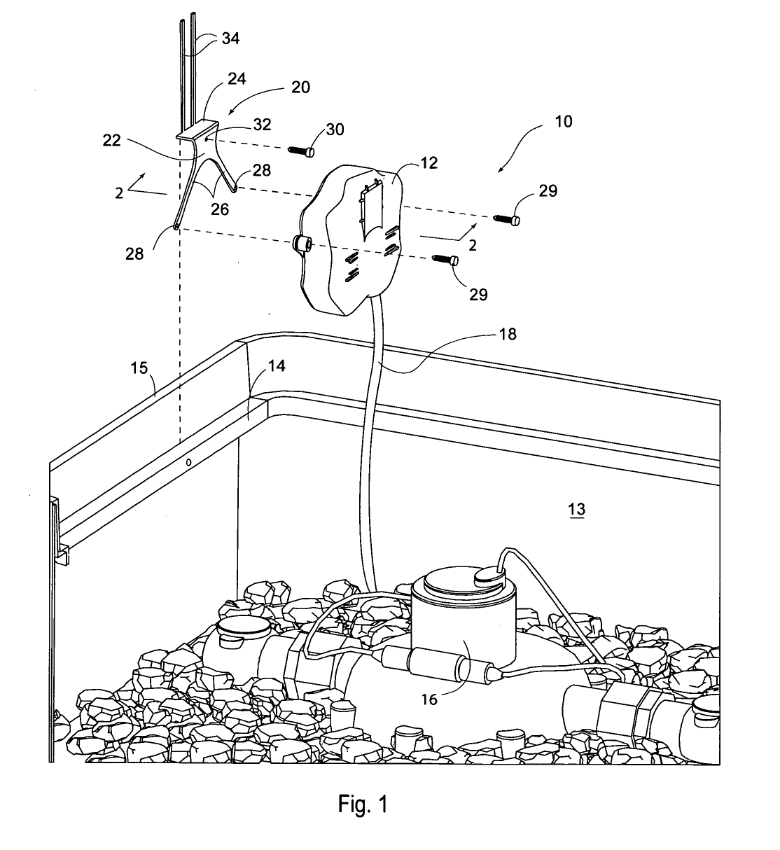

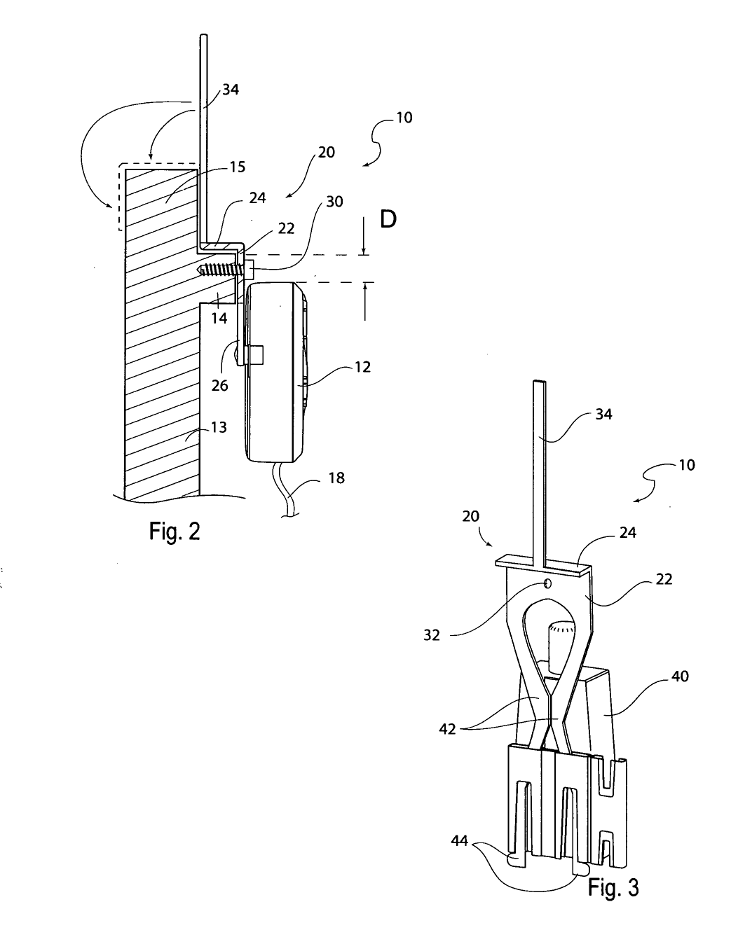

FIG. 1 is an exploded perspective view of the transponder system 10 including a first embodiment of the utility meter transponder 12, and a mounting bracket 20 for mounting the utility meter transponder 12 to the meter box 13. FIG. 2 is a sectional view thereof taken along line 2-2 in FIG. 1. As shown in FIGS. 1 and 2, the mounting bracket 20 includes a base element 22 adapted to abut the meter box 13, and a mounting flange 24 extending outwardly from the base element 22. The mounting flange 24 is adapted to engage and rest upon the lip 14 of the meter box 13.

For purposes of this application, the term lip 14 shall be expressly defined to include the perimeter 15 of the meter box 13, which is structurally equivalent to the lip 14. The mounting bracket 20 further includes a transponder mounting element 26 extending downwardly from the base element 22 opposite the mounting flange 24. The transponder mounting element 26 is adapted to mount the utility meter transponder 12 on the mounting bracket 20. The transponder mounting element 26 is shaped and sized to maintain the utility meter transponder 12 a predetermined distance D from the lip 14 of the meter box 13.

In the embodiment of FIGS. 1 and 2, the transponder mounting element 26 preferably includes a downwardly extending leg having a mounting aperture 28, and a mounting fastener 29 for extending through the mounting aperture 28 and into the utility meter transponder 12. In the preferred embodiment, the transponder mounting element 26 includes a pair of the downwardly extending legs each having a mounting aperture 28. In the most preferred embodiment, the mounting fastener 29 is a screw or similar element, and the mounting aperture 28 is internally threaded or otherwise adapted to threadedly engage the screw 29. Alternative embodiments are described in greater detail below.

The mounting bracket 20 is preferably constructed of a relatively rigid, strong, and corrosion-resistant material such as galvanized steel, aluminum or the like, although it could be constructed of a wide range of materials, including suitable plastics and other similar or equivalent materials.

As shown in FIGS. 1 and 2, a fastener 30 is adapted to fasten the base element 22 to the meter box 13 once the mounting flange 24 has engaged the lip 14. The fastener 30 is preferably a screw or equivalent element that is adapted to fit through a fastener aperture 32 of the base element 22 and engage the meter box 13, threadedly or otherwise. In alternative embodiments, the fastener 30 may be a piece of double-sided adhesive (not shown), a clamping element for clamping the lip 14 or any other similar or equivalent fasteners or fastening systems known to those skilled in the art.

In the preferred embodiment, the mounting bracket 20 further comprises an upwardly extending element 34 or arm extending from an outer edge of the mounting flange 24. The upwardly extending element 34 is pliant and adapted to be bent around a top perimeter 15 of the meter box 13, for further securing the mounting bracket 20.

The invention further includes a method for mounting the utility meter transponder 12 in the meter box 13 using the mounting bracket 20 described above. The base element 22 is mounted, fastened, or otherwise attached to the meter box 13 such that the mounting flange 24 engages the lip 14 of the meter box 13. The utility meter transponder 12 is mounted on the transponder mounting element 26, and the mounting bracket 20 functions to maintain the utility meter transponder 12 a predetermined distance D from the lip 14 of the meter box 13.

In the embodiment wherein the mounting bracket 20 further includes the upwardly extending element 34, the upwardly extending element 34 is bent around the top perimeter 15 of the meter box 13 to further secure the mounting bracket 20 in place.

FIG. 3 is rear perspective view of a second embodiment of the transponder system 10. In this embodiment, the transponder mounting element includes two downwardly extending legs 42 that biased towards a locking position, as shown in FIG. 3, but can flex to an unlocking position for receiving and lockingly engaging an alternative embodiment of a utility transponder 40. In the most preferred embodiment, each of the downwardly extending legs 42 includes a locking tab 44 that extends outwardly from the leg 42 for locking the utility transponder 40 on the mounting bracket 20 and for preventing it from being knocked off.

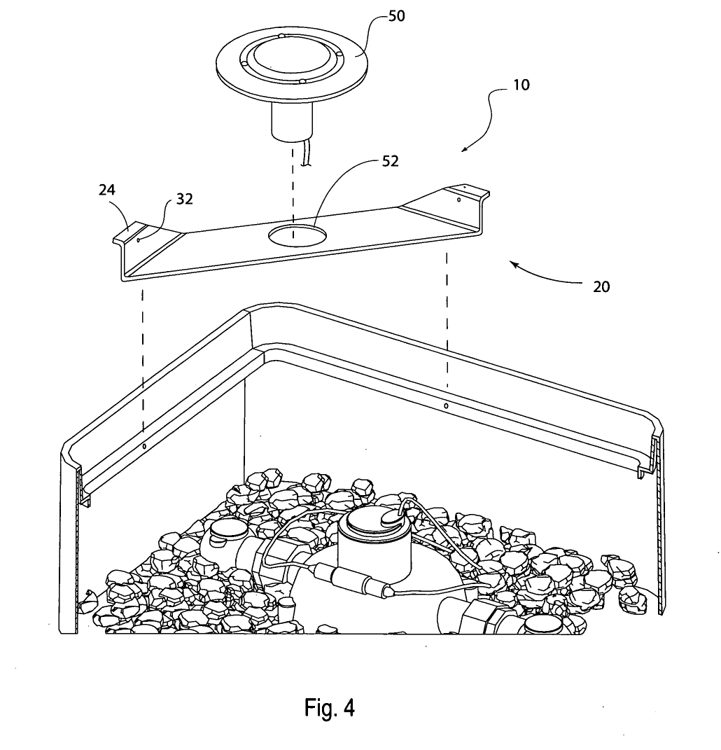

FIG. 4 is front perspective view of a third embodiment of the transponder system 10. In this embodiment, the transponder mounting element of the mounting bracket 20 is an aperture 52 adapted to receive the utility meter transponder 50. Once this embodiment of the mounting bracket 20 has been installed by mounting the mounting flange 24 on the lip 14, as previously discussed, the utility meter transponder 50 is inserted into the aperture 52 and physically supported by the mounting bracket 20.

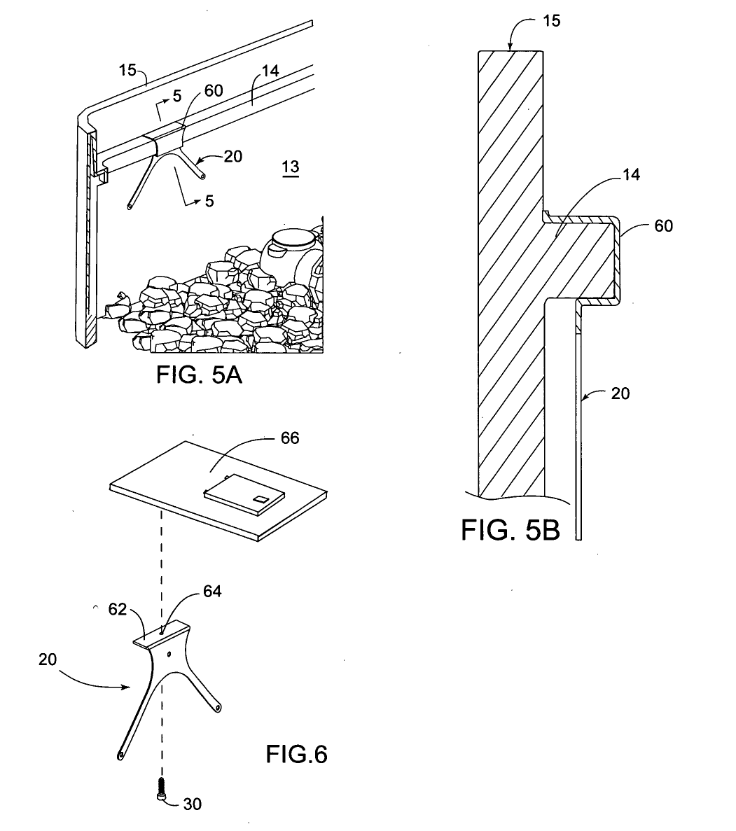

FIG. 5A is a perspective view of a fourth embodiment of the transponder system, and FIG. 5B is a sectional view thereof taken along line 5-5 in FIG. 5A. As illustrated in FIGS. 5A and 5B, the fastener of the mounting bracket 20 may be a clamping element 60 that is adapted to clamp the lip 14, as illustrated, or alternatively to clamp the perimeter 15, or other suitable element. The clamping element 60 may be a generally U-shaped element that is resilient and shaped to engage the lip 14; and in alternative embodiments, the clamping element 60 may also include a spring (not shown), or other shape, construction, or configuration known to those skilled in the art.

FIG. 6 is a perspective view of a fifth embodiment of the transponder system. In this embodiment, the mounting bracket 20 includes a mounting flange 62 with an aperture 64 for receiving the fastener 30, so that the mounting bracket 20 may be attached to a lid 66 of the meter box 13.

While several embodiments of the mounting bracket 20 have been illustrated, each being adapted to work with a specific design of the utility meter transponder 12, those skilled in the art may devise alternative embodiments of the mounting bracket 20 to accomplish the goals described herein. Such alternative embodiments should be considered within the scope of the invention, as presently claimed.

Certain terminology is used in the preceding description for convenience only, and is not limiting. The terminology includes the words described above, similar or equivalent words, and derivatives thereof. Additionally, the words “a,” “an,” and “one” are defined to include one or more of the referenced item unless specifically stated otherwise. Also, the terms “have,” “include,” “contain,” and similar terms are defined to mean “comprising” unless the like, designate directions from the geometric center of the object being described.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A mounting bracket for mounting a utility meter transponder on a lip of a meter box, the mounting bracket comprising:
a base element adapted to abut the meter box;
a mounting flange extending outwardly from the base element, the mounting flange being adapted to engage the lip of the meter box;
a fastener adapted to fasten the base element to the meter box once the mounting flange has engaged the lip; and
a transponder mounting element extending from the base element opposite the mounting flange, the transponder mounting element being adapted to mount the utility meter transponder, wherein the transponder mounting element is shaped and sized to maintain the utility meter transponder a predetermined distance from the lip of the meter box.

2. The mounting bracket of claim 1, wherein the transponder mounting element includes a downwardly extending leg having a mounting aperture, and a mounting fastener for extending through the mounting aperture and into the utility meter transponder.

3. The mounting bracket of claim 1, wherein the transponder mounting element includes a pair of downwardly extending legs each having a transponder engagement element.

4. The mounting bracket of claim 3, wherein the downwardly extending legs are biased towards a locking position.

5. The mounting bracket of claim 1, further comprising an upwardly extending element extending from an outer edge of the mounting flange, the upwardly extending element being pliant and adapted to be bent around a top perimeter of the meter box.

6. The mounting bracket of claim 1, wherein the transponder mounting element is an aperture adapted to receive the utility meter transponder.

7. A transponder system adapted to be mounted in a meter box having a lip, the transponder system comprising:
a utility meter transponder; and
a mounting bracket for mounting the utility meter transponder on the lip of the meter box, the mounting bracket comprising:
a base element adapted to abut the meter box;
a mounting flange extending outwardly from the base element, the mounting flange being adapted to engage the lip of the meter box; and
a transponder mounting element extending downwardly from the base element opposite the mounting flange, the transponder mounting element being adapted to mount the utility meter transponder, wherein the transponder mounting element is shaped and sized to maintain the utility meter transponder a predetermined distance from the lip of the meter box.

8. The transponder system of claim 7, wherein the transponder mounting element includes a downwardly extending leg having a mounting aperture, and a mounting fastener for extending through the mounting aperture and into the utility meter transponder.

9. The transponder system of claim 7, wherein the transponder mounting element includes a pair of downwardly extending legs each having a transponder engagement element.

10. The transponder system of claim 10, wherein the downwardly extending legs are biased towards a locking position, but can flex to an unlocking position.

11. The transponder system of claim 7, further comprising an upwardly extending element extending from an outer edge of the mounting flange, the upwardly extending element being pliant and adapted to be bent around a top perimeter of the meter box.

12. The transponder system of claim 7, further comprising a fastener adapted to fasten the base element to the meter box once the mounting flange has engaged the lip.

13. A method for mounting a utility meter transponder in a meter box a predetermined distance from a lip, the method comprising the steps of:
providing a mounting bracket for mounting the utility meter transponder, the mounting bracket comprising:
a base element;
a mounting flange extending outwardly from the base element; and
a transponder mounting element extending downwardly from the base element opposite the mounting flange;
fastening the base element to the meter box such that the mounting flange engages the lip of the meter box; and
mounting the utility meter transponder on the transponder mounting element, the mounting bracket functioning to maintain the utility meter transponder a predetermined distance from the lip of the meter box.

14. The method of claim 13, wherein the mounting bracket further includes an upwardly extending element extending from an outer edge of the mounting flange, the upwardly extending element being pliant.

15. The method of claim 14 further comprising the step of:
Bending the upwardly extending element around a top perimeter of the meter box.
